(19) United States
(12) Patent Application Publication
(10) Pub. No.: US 2026/0370076 A1
(43) Pub. Date: Nov. 19, 2026

(54) THREE-PHASE ASYNCHRONOUS MOTOR WITH PASSIVE ROTOR

(71) Applicant: ADDITIVE | DRIVES GMBH, Dresden (DE)

(72) Inventor: Axel Helm, Dresden (DE)

(21) Appl. No.: 19/471,029

(22) PCT Filed: Mar. 6, 2024
(86) PCT No.: PCT/EP2024/055845

§ 371 Date: Sep. 30, 2025

(30) Foreign Application Priority Data
Apr. 6, 2023 (DE) 10 2023 108 848.3
Oct. 11, 2023 (DE) 10 2023 127 815.0

(51) Int. Cl. H02K 3/28; H02K 17/12

(52) U.S. Cl. CPC H02K 3/28; H02K 17/12

(57) ABSTRACT

Disclosed is a three-phase asynchronous motor with a passive rotor and stator, which includes a laminated core with slots. The slots accommodate a plurality of pulled coils made of solid copper material using hairpin technology and the rotor is designed as a copper rotor. The winding head of the stator can be realised by additive, layer-by-layer application and locally selective solidification of a conductive material, such as a copper material. Further disclosed is a distributed, pitch-free hairpin winding with a number of strand windings in the range of ≥100, wherein 10 to 16 hairpins are located in each of the slots, so that a limit efficiency factor according to IEC-60034-02 of ≥IE 4, and ≥IE 5, can be achieved in a speed range of at least up to 2000 rpm.

The invention relates to a three-phase asynchronous motor with a passive rotor and stator, comprising a laminated core with slots, wherein the slots accommodate a plurality of pulled coils made of solid copper material using hairpin technology, and the rotor is designed as a copper rotor, and furthermore the winding head of the stator can preferably be realised by additive, layer-by-layer application and locally selective solidification of a conductive material, in particular a copper material, according to the preamble of claim 1.

Methods for manufacturing a stator for electrical machines, in particular for an electric motor or generator, using so-called hairpin technology belong to the state of the art.

Hairpins can replace windings that are manufactured using classic winding methods, such as needle winding. A hairpin can be produced in particular by appropriately forming a solid metal wire, in particular a solid copper wire.

Hairpin technology therefore uses plug-in coils that are inserted into the stator slots of the stator laminated core. In this regard, plug-in coils in a so-called U-geometry are already known. Alternatively, pins in so-called I-pin technology are used.

In recent years, hairpin technology has been increasingly used in the automotive industry to increase the efficiency of electric vehicle drives.

In the industrial sector, the asynchronous motor, usually designed as a three-phase asynchronous machine, is still the predominant type. The advantage over other types of electric motors is the absence of a commutator and brushes. Asynchronous motors consist of an outer, stationary stator and a rotating rotor. When operating such asynchronous motors on three-phase networks, the number of copper windings in the stator is three or a multiple thereof, with a corresponding phase shift of the currents in adjacent windings of 120°.

For the rotors of a three-phase asynchronous motor, a distinction is made between the designs short-circuit or squirrel-cage rotors as well as slip ring rotors.

In addition to the robust design of an asynchronous motor, another advantage is that, according to its operating principle, no cost-intensive permanent magnets are required. Asynchronous motors can be operated easily via a voltage-frequency control. No complex sensor technology is required.

The efficiency of asynchronous motors is measured by their efficiency factor. The International Efficiency Code (IE Code) was introduced for global standardisation. The quantitative description of the IE Code as well as the technical background are part of the international standard IEC 60034-30-1:201. In Germany, the derivation according to DIN EN 60034-30-1VDE 0530-30-1:2014-12 must be observed.

This standard establishes four or five efficiency classes and specifies the corresponding minimum efficiency factors for respectively defined rated power.

From the standard it can be seen that the required efficiency factor increases with rising IE classification. For energy-efficient asynchronous machines, the IE 4 rating is therefore considered state of the art.

In line with the goal of complete climate neutrality in Europe by 2050, among other things a significant improvement in energy efficiency must be achieved in the field of usage by industrial consumers. Approximately 70% of the electrical energy consumed is accounted for by applications with electric drives, such as pumps, fans, compressed air generation installations, cooling compressors, conveyor installations and the like.

For the above reason, not only the improvement of the efficiency factor of electric drives in vehicles, but also the pursuit of high efficiency factors in general electrical drives is becoming increasingly important.

Based on the above, the object of the invention is to provide an advanced three-phase asynchronous motor for industrial applications which, according to its respective performance class, achieves an energy efficiency rating that up to now could not be achieved with conventional machines.

The solution to the object of the invention is provided by a three-phase asynchronous motor with a passive rotor and stator in accordance with its definition in patent claim 1, whereby the dependent claims comprise at least appropriate embodiments and further developments.

It is therefore started from a three-phase asynchronous motor known per se with a passive rotor and stator.

The stator comprises a laminated core with slots, wherein the slots accommodate a plurality of pulled coils made of solid copper material using hairpin technology.

The rotor is designed as a copper rotor.

Furthermore, the winding head of the stator is preferably realised by additive, layer-by-layer application and locally selective solidification of a conductive material, in particular copper material.

According to the invention, the motor has a distributed, pitch-free hairpin winding with a number of strand windings in the range of ≥100, wherein 10 to 16 hairpins are located in each of the slots, so that a limit efficiency factor according to IEC-60034-02 of ≥IE 5 can be achieved in a speed range of at least up to 2000 rpm.

The dimensioning of the hairpin winding and the winding head is done with the aim of a minimum strand resistance and a reduced limit value with regard to stator heat losses for the respective motor power class.

This makes use of the knowledge that at least one third of the heat losses of such a motor are caused by the stator design.

The motor according to the invention is also characterised by a low-pole design with two pole pairs.

The number of slots of the motor lies in the range between 60 and 120, preferably between 60 and 96.

The hairpins have a rectangular cross-section, which also applies to the corresponding slots.

The winding of the motor according to the invention consists exclusively of hairpin plug-in coils with maximum slot fill factor.

The air gap between stator and rotor laminated core is in the range of ≤0.30 mm, which is comparatively approx. 25% smaller than in conventional IE 4 asynchronous motors.

The reduced slip in addition to that reduces losses in the rotor winding.

Preferably, copper is employed instead of aluminium for realising the rotor short circuit cage. The motor's strand winding is designed as a star connection, and all conductors of a strand are connected in series.

The stator winding is designed as a wave winding, wherein each strand winding encircles the stator several times in the circumferential direction and terminates at the star point.

Thanks to additive technology, the winding head can be designed to be mechanically self-supporting, wherein the winding head connectors have a variable step width.

The invention therefore implements the knowledge of dominant loss mechanisms and leads to an optimised design of an asynchronous machine. The use of a winding without pitch results in a winding factor that measures the coupling between the stator and rotor windings and is >95%.

The improved coupling achieved reduces the magnetising current and thus reduces the copper losses in the stator winding. Compared to pitched windings, the winding factor is essentially <90%.

A provided large number of holes in the range of ≥5 and an associated large number of stator slots reduce the Oberfelder-scattering numeral to a range of <0.75%. This results in a minimisation of harmonic losses in the rotor. The large number of holes has the advantage over a conventional pitch that the winding factor is reduced to a lesser extent.

The number of stator slots of the machine according to the invention is essentially 50% greater than that of so-called standard norm motors.

The aforementioned star connection, combined with high winding factors >95% with regard to the distributed winding used according to the invention, results in the smallest possible number of windings compared to the widely used delta connection.

The smallest possible number of windings allows for copper cross-sections as large as possible and thus a maximisation of the copper fill factor to a range >70%. Copper losses in the stator slot are inversely proportional to the copper fill factor.

Standard norm motors have a copper fill factor of approx. 35%, which results in twice as much stator copper losses compared to the solution according to the invention.

Starting from the smallest possible number of windings as well as the aforementioned series connection of all conductors in a strand, solid copper rods can be used instead of conventional round wires.

This improves the copper fill factors on the one hand, but also the thermal coupling between stator winding and laminated core on the other. This in turn reduces the winding temperatures, which leads to a reduction in losses in the stator.

The choice of rectangular stator slots in conjunction with solid copper rods results in the best possible utilisation of the motor volume, i.e. an optimal filling with the active materials iron and copper.

This results in a minimisation of magnetic flux density and electric current density, thereby minimising iron and copper losses.

The motor according to the invention is therefore characterised by a wave winding in the stator and a mechanically self-supporting winding head.

The winding head connectors have the aforementioned variable step width in the range of m×q±1, where m=number of strands and q=number of holes. As mentioned, the variance in the step width of the winding head connector serves to geometrically compact the respective stator winding head.

Due to the solid copper conductors used, the winding head is self-supporting, i.e. no additional fastening elements are installed during assembly.

Although the formation of the winding head by additive, layer-by-layer application and locally selective solidification of a copper material is preferred, a winding head can also be formed from solid copper rods, whereby the connection of the hairpins to the elements of the winding head can be realised, for example, by welding or soldering.

In comparison to standard motors, in which round wire is usually used on the winding side and in which there is winding pitch, which necessitates additional layer insulation in the slot, according to the invention a significantly higher copper fill factor well above the 35% of standard machines is achieved.

Likewise, the motor according to the invention does not have the typical round wire loop winding in the winding head found in standard motors.

According to a preferred embodiment of the invention, the number of strand windings is in the lower range of the electromagnetically sensible spectrum. This maximises the copper fill factor, as a small number of strand windings leads to a reduction of the proportion of insulating material in the stator slot in question.

The slot support width of the stator slots is chosen to be very small, in the range of ≤1.5 mm. This is technically possible because the hairpins can be inserted axially into the laminated core during assembly.

Conventional round wire solutions, on the other hand, require correspondingly larger slot openings in order to insert the winding wire.

Small slot widths also reduce the actual air gap between the rotor and stator. This leads to a reduction in stator current and thus to a reduction in occurring losses.

1. A three-phase asynchronous motor with passive rotor and stator, comprising:
a laminated core with slots, wherein the slots accommodate a plurality of pulled coils made of solid copper material using hairpin technology, and the rotor is designed as a copper rotor; and
a pitch-free hairpin winding with a number of strand windings greater than 100, wherein 10 to 16 hairpins are located in each of the slots, so that a limit efficiency factor according to IEC-60034-02 of ≥IE 4, in particular ≥IE 5, can be achieved in a speed range of at least up to 2000 rpm.

2. The three-phase asynchronous motor according to claim 1, wherein the dimensioning of the hairpin winding and the winding head is done with the aim of a minimum strand resistance and a reduced limit value with regard to stator heat losses for the respective motor power class.

3. The three-phase asynchronous motor according to claim 1, wherein the three-phase asynchronous motor is a low-pole design with two pole pairs.

4. The three-phase asynchronous motor according to claim 1, wherein the number of slots lies in the range between 60 and 96.

5. The three-phase asynchronous motor according to claim 1, wherein the hairpins have a rectangular cross-section.

6. The three-phase asynchronous motor according claim 1, wherein the winding consists exclusively of hairpin plug-in coils with maximum slot fill factor.

7. The three-phase asynchronous motor according to claim 1, wherein the air gap between the stator and rotor laminated core is in the range of ≤0.3 mm.

8. The three-phase asynchronous motor according to claim 1, wherein the strand winding is designed as a star connection and all conductors of a strand are connected in series.

9. The three-phase asynchronous motor according to claim 8, wherein the stator winding is designed as a wave winding, wherein each strand winding encircles the stator multiple times in the circumferential direction and terminates at the star point.

10. The three-phase asynchronous motor according claim 1, wherein the winding head is designed to be mechanically self-supporting, wherein the winding head connectors have a variable step width.
